(19) United States
(12) Patent Application Publication
(10) Pub. No.: US 2022/0215749 A1
(43) Pub. Date: Jul. 7, 2022

(54) METHOD FOR PREDICTING AT LEAST ONE PROFILE OF THE SPEED OF A VEHICLE ON A ROAD NETWORK

(71) Applicant: IFP Energies nouvelles, Rueil-Malmaison (FR)

(72) Inventors: Mohamed LARAKI, RUEIL-MALMAISON CEDEX (FR); Giovanni DE NUNZIO, RUEIL-MALMAISON CEDEX (FR); Laurent THIBAULT, RUEIL-MALMAISON CEDEX (FR)

(21) Appl. No.: 17/610,694

(22) PCT Filed: May 18, 2020
(86) PCT No.: PCT/EP2020/063828

§ 371 Date: Nov. 11, 2021

(30) Foreign Application Priority Data
May 28, 2019 (FR) FR1905686

(51) Int. Cl. G08G 1/052; G08G 1/01; G01C 21/34

(52) U.S. Cl. CPC G08G 1/052; G01C 21/3492; G08G 1/0129

(57) ABSTRACT

The invention relates to a method of predicting at least one vehicle speed profile for a road network portion (POR), wherein a vehicle speed model (MOD) is constructed by use of macroscopic road network data (MAC) and of travelled route data (DTR), and then this model is applied to the road network portion (POR) being considered.

### CROSS-REFERENCE TO RELATED APPLICATION

This application claims priority from International Application No. PCT/EP2020/063828 filed May 18, 2020 and French Application No. 19/05.686 filed May 28, 2019 which are hereby incorporated herein by reference in their entirety.

### BACKGROUND OF THE INVENTION

### Field of the Invention

The present invention relates to the prediction of a vehicle speed on a road network.

### Description of the Prior Art

According to the World Health Organization (WHO), about 18,000 deaths per day can be attributed to poor air quality, which brings the estimate to about 6.5 million deaths per year. Air pollution also represents a major financial issue which according to a Senate committee of inquiry, the total is an estimated cost of air pollution ranging between 68 and 97 billion Euros per year in France, as assessed in July 2015, considering both the health damage caused by pollution and its consequences on buildings, ecosystems and agriculture. The transport sector still represents a major source of emissions despite the many measures taken by the public authorities and the technological advances in the field. Transport, across all modes, is responsible for about 50% of global nitrogen oxides (NOx) emissions and about 10% of PM2.5 particulate emissions. Road transport alone makes a significant contribution to transport-related emissions, with 58% of the NOx emissions and 73% of the PM2.5 particulate emissions. These emissions are mainly due to three factors: exhaust emissions, abrasion emissions and evaporative emissions. Although heavy-duty trucks are the main pollutant emitters, passenger vehicles, which are more present in densely populated urban areas, have the highest impact on citizens' exposure to poor air quality.

Measures taken locally for transport management (such as better transport planning and incentives for modal shift), as well as progressive fleet renewal, have contributed to limiting exhaust gas emissions from road transport in cities and urban areas. Indeed, worldwide, the road transport activity has increased by a quarter in the last decade, whereas NOx emissions have increased by 5% and particulate emissions have decreased by 6%. Despite such improvements, the pollution levels still exceed the thresholds set by the WHO in many cities.

Similarly, current air quality monitoring tools do not allow precise isolation and estimation of the proportion of real-world road transport emissions, or their location in space. Indeed, emissions assessment is based on the use of an average method adapted to large scales, typically road segments of several kilometers so that the route can be considered to be representative of all the traffic conditions, as in the COPERT methodology Computer Program to calculate Emissions from Road Transports).

It is therefore difficult for cities to make the right decisions regarding road infrastructure development or in terms of legislation without the specific tools for assessing and predicting the impact of the measures considered on road transport emissions and air quality. These new tools should ideally allow evaluation of the impact of such measures at very fine ground time and spatial scales (of the order of a minute and of the order of ten meters).

Pollutant emissions (at least one of chemical and noise emissions) are related to the travel speed of vehicles on the road. Therefore, in order to have good emissions forecasts, it is important to accurately predict the speed of vehicles on the road, by taking account of the road topology (slope, bend, road signs, etc.) and the traffic conditions.

Furthermore, vehicle consumption is also related to the speed of the vehicle. Therefore, in order to precisely determine the consumption of a vehicle, it is important to accurately predict the speed of vehicles on the road, by accounting for the road topology (slope, bend, road signs, etc.) and the traffic conditions.

Another field where vehicle speed prediction is useful is the determination of routes for vehicle navigation. Indeed, precise prediction of the speed of vehicles on the road by taking account notably of the road topology and the traffic conditions provides optimized navigation, especially in terms of travel time.

Knowledge of the speed of vehicles also has an impact on road safety.

### BACKGROUND OF THE INVENTION

Several methods have been developed to determine the speed of vehicles.

The most widespread method determines an average vehicle speed. This method can notably be based on the exploitation of traffic measurements for estimating a single value for the average speed per road segment. This method does not provide accurate speed measurements and it does not allow accounting for the impact of the road infrastructure, or the various driving styles or road sign-related behaviours. Moreover, this method requires recent traffic measurements. For most average speed estimation methods, it is not possible to assess a speed for a road segment without traffic measurement. For example, patent application CN-109,003,453 describes an average speed estimation method.

Another method is based on an estimation of a statistical speed corresponding to the 85% percentile by use of statistical models. This method involves the same drawbacks as the previously described method: lack of precision, lack of consideration of the impact of road infrastructures, of the various driving styles or road sign-related behaviors, and inability to predict a speed for a road segment without traffic measurement. For example, the document by Lamm, Ruediger, Basil Psarianos and Theodor Mailaender, Highway Design and Traffic Safety Engineering Handbook. 1999 describes such a method.

The method of reconstructing a driving cycle is based on a travelled route data history known as FCD (Floating Car Data). This database is decomposed and clustered according to macroscopic descriptors, such as the road type. Each road segment is then identified as belonging to a cluster. One or more speed profiles are constructed on this segment by combining real speed portions obtained from the FCD data belonging to this cluster. This method also lacks precision; indeed, the models used are relevant at a large spatial scale only, but they may lead to inconsistent behaviors. Furthermore, this method, which can be computational time consuming, does not allow the impact of the road infrastructure to be taken into account directly and in detail. For example, the document by Effa, R. C., L. C. Larsen. 1993, Development of Real-World Driving Cycles for Estimating Facility-Specific Emissions from Light-Duty Vehicles, Presented at Air and Waste Management Assoc. Specialty Conf. Emission Inventory: Perception and Reality, Pasadena, Calif., describes such a method.

Another method is based on the calculation of a speed profile according to the distance by use of mathematical functions, considering the road signals and the infrastructure for each road segment. This method is not satisfactory in terms of consideration of the various driving behaviors and styles, and of the road topology. Moreover, most processes based on this method cannot be used for a road segment for which no history is available. The document Andrieu, C. (2013). Modélisation fonctionnelle de profils de vitesse en lien avec I'infrastructure et méthodologie de construction d'un profit agrégé (Doctoral dissertation, Université Paul Sabatier-Toulouse III) describes such a method.

Furthermore, there is a method for classifying speed profiles based on microscopic descriptors related to the speed profiles, one or more typical profiles being then associated with each road segment. This method also lacks precision (reconstruction is based only on an average of the historical data), it does not allow consideration of the traffic conditions (congestion) or of the road topology, and it lacks exploitability because it requires microscopic data that is not always known. This method is notably described in the document Laureshyn, Aliaksei, Kalle Åström and Karin Brundell-Freij. “From Speed Profile Data to Analysis of Behaviour: Classification by Pattern Recognition Techniques,” IATSS research 33.2 (2009): 88-98.

### SUMMARY OF THE INVENTION

The present invention predicts a precise speed profile at a fine spatial scale by considering the various driving behaviors and styles without microscopic data. The invention therefore relates to a method of predicting at least one speed profile of a vehicle for a portion of a road network, wherein a vehicle speed model is constructed by use of a model of macroscopic road network data and travelled route data, then this model is applied to the road network portion considered.

The invention relates to a method of predicting at least one vehicle speed profile on a road network portion. The following steps are carried out for this method:
a) constructing a vehicle speed model using a machine learning method by use of macroscopic data of the road network and by use of data relative to routes travelled on the road network, the vehicle speed model being associating to at least one subdivision of the road network at least one vehicle speed profile according to the macroscopic data of the road network and the travelled route data; and
b) predicting at least one speed profile of the vehicle on the portion of the road network by applying the vehicle speed model to macroscopic data of each subdivision of the portion of the road network.

According to one embodiment, the vehicle speed model is constructed by carrying out the following steps:
i) segmenting the road network by means of the macroscopic data of the road network;
ii) categorizing each segment of the road network according to the macroscopic data of the road network;
iii) for each road segment category, classifying the travelled route data; and
iv) for each road segment category and for each classification of the travelled route data, generating at least one vehicle speed profile by use of the travelled route data.

According to one implementation of the invention, at least one vehicle speed profile is predicted for the portion of the road network by carrying out the following steps:
i) segmenting the portion of the road network,
ii) categorizing the segments of the portion of the road network; and
iii) assigning to each segment of the portion of the road network the at least one vehicle speed profile generated by use of the vehicle speed model.

Preferably, the at least one speed profile is assigned to each segment of the portion of the road network by accounting for data relative to routes travelled on each segment to clarify the at least one speed profile.

Advantageously, a distribution of the at least one speed profile is also assigned to each segment of the portion of the road network.

According to an embodiment option, the road network is segmented by dividing the road network into connection triplets, each connection triplet consisting of a connection formed between two nodes of the road network, its origin and its destination.

According to one aspect, the category of the road network segment is selected from among:
a) a congested road;
b) an uncongested or minimally congested road with a traffic light;
c) an uncongested or minimally congested road without a traffic light and with an intersection with right of way;
d) an uncongested or minimally congested road without a traffic light and with an intersection without right of way;
e) an uncongested or minimally congested road without a traffic light and with a bend having curvature; and
f) an uncongested or minimally congested road without a traffic light and with a bend having a larger curvature.

According to one feature, the travelled route data is classified by a classification algorithm which is the k-means algorithm.

According to one embodiment, at least one vehicle speed profile is generated by a method based on at least one neural network for parametrizing a speed function depending on distance, preferably the speed function is a linear function, a parabola function or a combination of at least one of linear and parabola functions of the distance.

According to one implementation, the macroscopic data of the road network is the topology and the traffic conditions, preferably and the macroscopic data of the road network provided by a geographic information system.

According to one aspect, the travelled route data comprises speed, position and altitude data measured during prior trips, preferably by use of a geolocation system.

According to one feature, the at least one vehicle speed profile of the road network portion is displayed on a road map, preferably by use of a smartphone or a computer system.

Furthermore, the invention relates to a method of predicting at least one of chemical and noise emissions on a road network portion, comprising steps of:
a) predicting at least one vehicle speed profile on the portion of the road network by use of the method of predicting at least one speed profile according to one of the above features, and
b) applying a microscopic model of at least one of chemical and noise emissions to the at least one speed profile for predicting the emissions, the model relating the vehicle speed to the emissions.

The invention also relates to a method of predicting the consumption of a vehicle on a road network portion, comprising steps of:
a) predicting at least one vehicle speed profile on the portion of the road network by use of the method of predicting at least one speed profile according to one of the above features; and
b) applying a vehicle consumption model to the at least one speed profile for predicting the consumption of the vehicle, the model relating the vehicle speed to the consumption of the vehicle.

Furthermore, the invention relates to a method of determining a route to be travelled by a vehicle, for which the departure and the arrival of said route are identified, by carrying out the steps of:
a) predicting at least one vehicle speed profile on the portion of the road network by use of the method of predicting at least one speed profile according to one of the above features; and
b) determining a route to be travelled for connecting the departure and the arrival, by accounting for at least one vehicle speed profile, which preferably minimizes the travel time.

### BRIEF DESCRIPTION OF THE FIGURES

Other features and advantages of the method according to the invention will be clear from reading the description hereafter of embodiments given by way of non-limitative example, with reference to the accompanying figures wherein:

FIG. 1 illustrates the steps of the method according to one embodiment of the invention;

FIG. 2 illustrates the construction of the speed model according to one embodiment of the invention;

FIG. 3 illustrates the prediction of a speed profile according to one embodiment of the invention;

FIG. 4 illustrates a portion of a road network;

FIG. 5 illustrates a speed profile for one example in case of a road with a traffic light being red;

FIG. 6 illustrates a speed profile for one example in the case of a road with a traffic light being green;

FIG. 7 illustrates, for one example, a comparison of measured speed profiles and of speed profiles predicted with the method according to one embodiment of the invention, in the case of a road with a traffic light when the light is red,

FIG. 8 illustrates, for one example, a comparison of measured speed profiles and of speed profiles predicted with the method according to one embodiment of the invention, in case of a road with a traffic light being green,

FIG. 9 illustrates, for one example, a comparison of the measured NOx emissions and of the NOx emissions estimated with the method according to one embodiment of the invention; and

FIG. 10 illustrates, for one example, a comparison of the measured NOx emissions and of the NOx emissions estimated with the method according to one embodiment of the invention.

### DETAILED DESCRIPTION OF THE INVENTION

The present invention relates to a method of predicting at least one speed profile of a vehicle on a portion of a road network. The method allows prediction of the speed of a vehicle travelling on a portion of a road network, the speed being expressed as a function of the distance to one end of the road. Since it is a prediction, it can be achieved even on a portion of a road network for which no prior route data is available. A speed profile is understood to be the vehicle speed variation along a road of a road network, the road network being made up of all of the roads for a given territory, a country or a region for example. In other words, the speed profile is dynamic (unlike an average speed). This speed variation allows accounting for the effects of the vehicle acceleration, and it therefore provides better representativity of the vehicle behavior. The road network portion is a part of this road network for which at least one vehicle speed profile is to be determined. The road network portion can be a set of roads between a starting point and an end point, a set of roads in a city or a district, etc.

Preferably, the vehicle is a motorized vehicle travelling within a road network, such as an automotive vehicle, a two-wheeler, a heavy goods vehicle, a coach, or a bus.

According to the invention, the following steps are carried out:
1. Construction of the vehicle speed model.
2. Prediction of at least one speed profile.

These steps can be carried out by computer. Step 1 can be carried out offline and step 2 can be carried out online. These steps are described in detail in the rest of the description.

FIG. 1 schematically illustrates, by way of non-limitative example, the steps of the method of predicting at least one speed profile according to an embodiment of the invention. The vehicle speed model (MOD) is constructed by use of macroscopic road network data (MAC) and of travelled route data (DTR). Vehicle speed model (MOD) then predicts (PRED) at least one speed profile (v) for the road network portion (POR) being considered.

### 1. Construction of the Vehicle Speed Model

This step constructs a vehicle speed model with a machine learning method by using macroscopic road network data and of data relative to routes already travelled on the road network. The macroscopic road network data allows accounting for information related to the road network, such as infrastructure, slope, road signs, traffic, etc. Travelled route data takes account of real behaviors in order to form a representative and accurate vehicle speed model. The vehicle speed model associates at least one subdivision of the road network (preferably one road network connection) at least one vehicle speed profile according to the macroscopic road network data and the travelled route data.

A subdivision of the road network is understood to be any partitioning of the road network. Preferably, the subdivision selected can be a connection of the road network. The road network connection is an elementary subdivision of the road network between two consecutive nodes of the road network. For example, a road network connection can be a road between two consecutive intersections, between two consecutive road signs, between an intersection and a road sign, or a part of a highway between two consecutive exits, etc. A fine division of the road network is thus available, as well as a vehicle speed model that is adapted to the road network without microscopic data. Thus, this division provides a prediction as representative as possible at a fine spatial scale.

According to one aspect of the invention, the macroscopic road network data can be the topology (that is the slope, the bends, the intersections, the road signs, etc.) and the traffic conditions. Preferably, the macroscopic road network data can be provided by a geographic information system (GIS). Examples of such geographic information systems are Here Maps™, Google Maps™, OpenStreetMap™. The macroscopic data is always available from any place. Thus, it can serve as input data for the vehicle speed model.

According to one aspect of the invention, the travelled route data can comprise data measured during prior trips, notably speed, position and altitude. Preferably, the travelled route data can be measured by use of a geolocation sensor such as a satellite-based positioning sensor, for example the GPS system (Global Positioning System), the Galileo system, etc. The geolocation system can be an in-vehicle or a remote sensor (using a smartphone for example).

According to one embodiment of the invention, the vehicle speed model can be constructed by carrying out the following steps:
1.1 Segmenting the road network.
1.2 Categorizing road network segments.
1.3 Classifying travelled route data.
1.4 Generating at least one speed profile.

These steps can be carried out by a computer. They are detailed in the rest of the description hereafter.

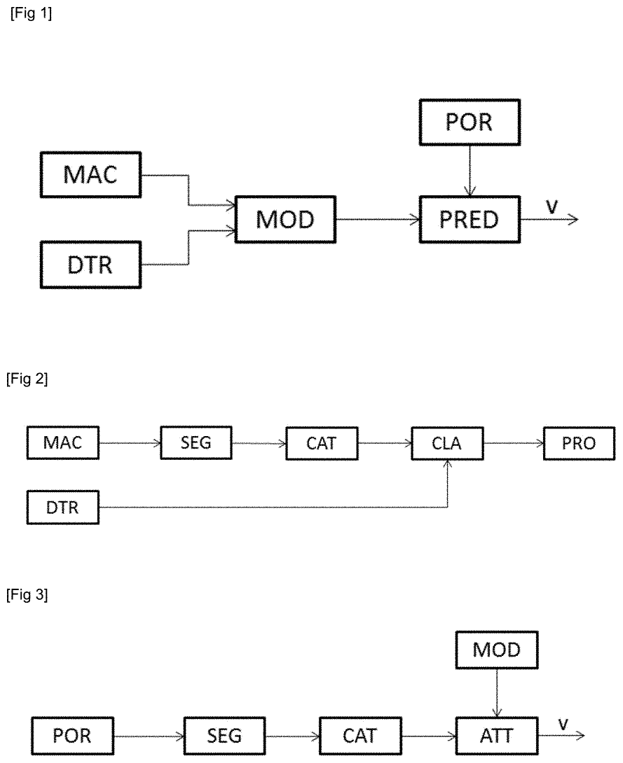

FIG. 2 schematically illustrates, by way of non-limitative example, the steps of constructing the vehicle speed model according to this embodiment of the invention. The road network is first segmented (SEG) by use of the macroscopic data (MAC). The road network segments obtained in the previous step are then categorized (CAT). The next step classifies (CLA) the travelled route data (DTR) for each road segment category (CAT). Finally, at least one speed profile (PRO) is generated for each road network segment and for each travelled route data classification.

### 1.1 Segmenting the Road Network

This step segments the road network by use of the macroscopic road network data. In other words, the road network is split into segments from the macroscopic road network data. The purpose of this step is to obtain road network subdivisions according to data such as the topology and the traffic conditions.

According to one implementation of the invention, the road network can be segmented by dividing the road network into connection triplets with each connection triplet comprising a connection formed between two nodes of the road network, its origin and its destination. There is a significant dispersion of the recorded speeds in the travelled route data depending on the driving style, the condition of the traffic signal system, the manoeuvres, origin and destination of each vehicle. This segmenting into connection triplets allows this dispersion to be limited by considering (in the next steps) only the speed data of vehicles having the same origin and the same destination. Furthermore, this segmenting step provides characteristics for each segment (each connection triplet), for example the manoeuvre angle, the number of triplets having the same central connection (number of connections), etc.

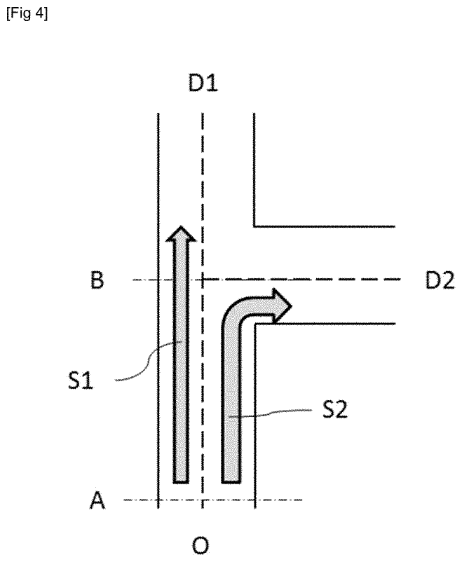

FIG. 4 illustrates a road comprising an intersection. This road has a connection between nodes A and B. The vehicle then has only one possible origin O and two possible destinations D1 and D2. Thus, according to the implementation of the invention described above, a first segment corresponding to the road of FIG. 4 can be the connection triplet (O, connection AB, D1) and the second segment corresponding to the road of FIG. 4 can be the connection triplet (O, connection AB, D2). Central connection AB is then common to two distinct segments (connection triplets).

Alternatively, the road can be segmented based on the road network connections, or by considering half of a connection so as to capture the effect of a road sign that can be in the middle of a segment defined by the macroscopic data of a geographic information system.

### 1.2 Categorizing Road Network Segments

This step categorizes each road network segment obtained in step 1.1 using macroscopic road network data. In other words, a category that includes the road segments having the same characteristics is associated with each road segment.

For the embodiment wherein the segment is a connection triplet, it is noted that two connection triplets having the same central connection can be found in different categories. Indeed, they may have different characteristics. For the example of FIG. 4, connection triplet (O, AB, D1) has no bend, unlike connection triplet (O, AB, D2).

According to one embodiment, the categories can be formed from the following criteria: congested or uncongested road, presence or absence of road signs (traffic lights for example), presence or absence of an intersection, priority road or not, extent of the curvature of a bend, functional class (characterizing the road network hierarchy and the segment importance level, for example highway, side street, etc.), number of lanes, etc. These criteria are directly obtained from the macroscopic road network data.

Advantageously, in order to limit the number of categories and to maintain a good representativity of the road network, the segment categories may be:
a congested road,
an uncongested or minimally congested road with a traffic light,
an uncongested or minimally congested road without a traffic light and with an intersection with right of way,
an uncongested or minimally congested road without a traffic light and with an intersection without right of way,
an uncongested or minimally congested road without a traffic light and with a bend having a small curvature, and
an uncongested or minimally congested road without a traffic light and with a bend having a large curvature.

In other words, for this embodiment, one of these six categories can be assigned to each segment. Indeed, it is generally unnecessary to subdivide the case of the congested road because, in this case, the speed is very low, and neither the road signs nor the road curvature has a significant impact on the vehicle speed.

### 1.3 Classifying Travelled Route Data

This step classifies the travelled route data for each road network segment category. The travelled route data, in particular the speed, is therefore associated with each road network segment. The similar travelled route data is then classified for each category. This step allows limiting the dispersion of measured data, in particular speed, such dispersion being notably induced by random phenomena (driving style, alternation of traffic lights, etc.).

This classification can be achieved from data (descriptors) such as the average speed on the segment, the speed of the 75% percentile, minimum/maximum speed, sum of the positive/negative accelerations, etc.

According to one feature of the invention, classification can be achieved using a k-means algorithm because the data used is numerical. The number k of classes (or similar speed profile classes) is a parameter of the algorithm that is determined with an iterative method intended to maximize a dissimilarity measure such as the “silhouette”. One important advantage of this method is the evaluation of the proximity of a data sample (in this case, a speed profile obtained from the travelled route data) in the center of a classification by also comparing it with the minimum average distance of another class. In general, a silhouette value above 0.5 indicates a good classification, with very little confusion and dispersion between the classes.

At this stage, according to the distribution of the travelled route data among the various classes, it is possible to estimate a proportion of data among classes and to associate it with a probability that a speed profile of a classification is verified (for example, the probability of stopping at a red light can be determined).

### 1.4 Generating at Least One Speed Profile

This step generates, for each road segment category (step 1.2) and for each classification obtained in the previous step, at least one speed profile by use of the prior route data. It is recalled that the speed profile is dynamic and that it corresponds to a speed variation as a function of distance within the same road segment portion. Indeed, one learns to generate and/or to group data belonging to the same category and class in order to bring out trends and speed behaviors. Thus, for each connection travelled at least once, a speed profile that approximates the data relative to the routes travelled on this connection is generated on this connection. The purpose of this step is to represent with a speed profile the typical behavior of vehicles according to the characteristics of the road and the prior routes travelled. Thus, the speed profiles are representative of real behaviors. These generated speed profiles form the vehicle speed model.

For the embodiment wherein the segment is a connection triplet, when the central connection belongs to two connection triplets, at least two speed profiles are generated for this central connection.

Advantageously, this step generates a speed function depending on the distance on the connection considered. The speed function can therefore be parametrized with the travelled route data. Advantageously, the speed function can be a polynomial function. Preferably (by simplification), the speed function can be a linear function, a parabola function or a combination of at least one of a linear and parabolic functions.

According to one embodiment of the invention, it is also possible, in this step, to assign a speed profile distribution to each road network segment category. Thus, it is possible to predict a speed profile probability.

According to an embodiment of the invention, it is possible to generate at least one vehicle speed profile by a neural network method, a support vector machine method, a random forest method or other supervised learning methods. The neural network method allows parametrizing of a speed function depending on distance, and this function can be a linear function, a parabolic function or a combination of at least one of linear and parabolic functions. An example of this embodiment is detailed in the rest of the description hereafter.

In order to properly estimate and reconstruct a typical speed profile, it is useful to estimate some parameters thereof. In particular, these useful parameters for speed profile generation can be the initial and final speeds of the profile on the segment being considered, as well as its maximum/minimum speed and the position of the possible stop point. Learning of these parameters can be achieved with a supervised method (by use of the travelled route data) to correlate them directly with macroscopic descriptors. The supervised learning tool used can be a neural network, which can use the following macroscopic descriptors as the input: classification (from the previous step) of belonging of the speed profile to be estimated, functional class of the triplet connections, number of lanes on the triplet connections, speed limitation on the triplet connections, average traffic speed on the triplet connections, length of the triplet connections, manouvre angle at the input and output of the central connection of the triplet, number of incoming/outgoing connections of the central connection, etc. In order to improve the learning performance and the estimation of the speed profile parameters, the method can be divided into two stages with cascade neural networks:
the first neural network can estimate the average of the initial speed and of the final speed, as well as their standard deviation, in order to obtain a Gaussian probability density. The Gaussian probability density has been selected for its ease of definition with few variables and for the good representativity of the phenomenon. This first neural network can be common to all the classes determined in the previous step,
the next neural networks can estimate the maximum and minimum speed, as well as the position of the stopping point. This neural network depends on the class to which the profile to be estimated belongs (for example a neural network that estimates the stopping point is used if the class includes a profile with a stopping point) and it takes as the input the estimation of the initial speed and of the final sped achieved by the previous neural network.

As regards the generation of typical speed profiles, it is possible to use the parameters estimated with deterministic or probabilistic polynomial methods, or other methods. In this embodiment of the invention, the polynomial method can be used without loss of generality. The polynomial functions used to generate the predicted speed profiles can be inspired by observing the real profiles of the travelled route data of each class. The profiles may essentially be reconstructed with linear or parabolic functions. The identified parameters can be randomly “drawn” according to their Gaussian distribution in order to generate several representative speed profiles. These generated speed profiles can meet the length and maximum/minimum speed requirements of the connection being considered for which the prediction is made.

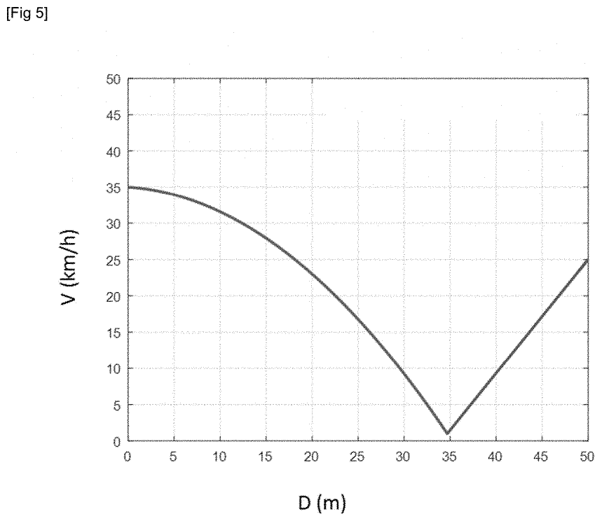

FIG. 5 schematically illustrates, by way of non-limitative example, a speed function V as a function of distance D. This speed function corresponds to a road connection with a “red” traffic light. The speed function has two parabolic functions: a first one decreasing down to a stopping point and a second one increasing from the stopping point.

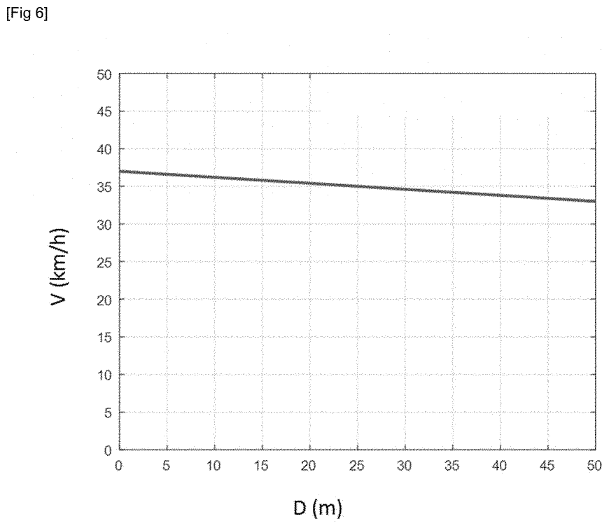

FIG. 6 schematically illustrates, by way of non-limitative example, a speed function V as a function of distance D. This speed function corresponds to a road connection with a “green” traffic light. The speed function is a decreasing linear function.

### 2. Prediction of at Least One Speed Profile

This step predicts at least one vehicle speed profile on the road network portion being considered. It is recalled that the speed profile is dynamic and that it corresponds to a speed variation as a function of distance within the road network portion being considered. It may be a road network portion that has been travelled during prior trips, a road network portion that has been partly travelled during prior trips or a road network portion that has not been travelled during prior trips (it may even be a non-existing road network portion for which a speed profile is to be predicted). In this step, the vehicle speed model constructed in step 1 is applied to the macroscopic data relative to the road network portion being considered. Thus, the topological data relative to the road network portion being considered is taken into account. Practically, at least one speed profile is assigned to each subdivision (preferably to each connection) of the road network portion considered.

Advantageously, speed profiles are determined for each connection of the road network portion being considered. It is thus possible to determine several behaviors and several driving styles for each connection of the road network portion. The speed profiles can be obtained in different ways, notably according to the embodiments that are implemented. The speed profiles for each connection can result from the fact that, for each road segment category, speed profiles are generated (step 1.4), each speed profile corresponding to a behavior or a driving style. Furthermore, the speed profiles for each connection can result from the fact that each connection may belong to several connection triplets, and the connection triplets may belong to distinct categories. Moreover, the speed profiles can result from random draws from among the determined speed profile distribution.

According to one embodiment of the invention, the speed profile prediction can be performed by the following steps:
2.1 Segmenting the road network portion
2.2 Categorizing the road network portion
2.3 Assigning at least one speed profile

These steps can be carried out by a computer. They are detailed in the rest of the description hereafter.

FIG. 3 schematically illustrates, by way of non-limitative example, the steps of this embodiment. The road network portion (POR) is segmented (SEG). The segments obtained in the previous step are then categorized (CAT). Finally, by use of vehicle speed model (MOD) and of categorization (CAT), each subdivision of the road network portion considered is assigned (ATT) at least one speed profile (v).

### 2.1 Segmenting the Road Network Portion

This step segments the road network portion being considered. Preferably, segmentation of the road network portion being considered can be achieved in the same way as the segmentation performed in step 1.1. Thus, preferably, the road network portion being considered can be segmented by connection triplets comprising an origin, a central connection and a destination.

### 2.2 Categorizing the Road Network Portion

This step categorizes the segments of the road network portion being considered. Preferably, categorization of the segments of the road network portion being considered can be achieved in the same way as the categorization is performed in step 1.2. Thus, preferably, the segments of the road network portion considered can be categorized into the following six categories:
a congested road,
an uncongested or minimally congested road with a traffic light,
an uncongested or minimally congested road without a traffic light and with an intersection with right of way,
an uncongested or minimally congested road without a traffic light and with an intersection without right of way,
an uncongested or minimally congested road without a traffic light and with a bend having a small curvature, and
an uncongested or minimally congested road without a traffic light and with a bend having a large curvature.

### 2.3 Assigning at Least One Speed Profile

This step assigns to each segment of the road network portion being considered at least one speed profile generated by use of the vehicle speed model, according to the road network portion categorization. In other words, the speed profile of the segment of the road network portion considered is identical to the speed profile of the segment having the same category in the vehicle speed model.

For example, a segment of the road network portion being considered which is a road with no or few congestions and with a traffic light, can have at least one speed profile as illustrated in FIG. 5 when the light is red, and at least one speed profile as illustrated in FIG. 6 when the light is green.

When the road network portion comprises at least one segment for which travelled route data is available, the speed profile can be calibrated with the travelled route data to optimize the speed profile prediction accuracy.

The method can comprise an optional step of displaying the speed profile for the road network portion being considered. In this optional step, the speed profile can be displayed on a road map. This display can be a rating or a color code. Optionally, a rating or a color can be associated with each connection of the road network. It can be displayed on board a vehicle: on the dashboard, on an autonomous mobile device such as a geolocation device (of GPS type), a mobile phone (of smartphone type). It is also possible to display the speed profile on a website. Furthermore, the predicted speed profile can be shared with the public authorities (road maintenance management for example) and public works companies. Thus, the public authorities and the public works companies can optimize the road infrastructure in order to improve safety or emissions levels.

According to one implementation of the invention, instantaneous speed measurements can be performed for at least one vehicle travelling on the road network, notably by use of geolocation systems (GPS, smartphone for example), or at least connected vehicles (for example with a sensor plugged in the diagnostics port OBD of the vehicle). The instantaneous speed data measured in real time during a trip can then be used to enrich and possibly recalibrate the speed profile prediction, optionally in step 2.3. Thus, the predicted speed profiles are representative of the real-time driving conditions. Therefore, the prediction of the associated indicators (consumption, emissions, noise, safety, etc.) is representative of the real-time driving conditions.

The present invention also relates to a method of predicting at least one of pollutant chemicals (NOx, particulate matter for example) and noise emissions on a road network portion. The following steps are carried out for this emissions prediction method:
a) predicting at least one vehicle speed profile on the road network portion considered by use of the method of predicting at least one speed profile according to any one of the variants or variant combinations described above, and
b) applying a microscopic model of at least one pollutant chemical and noise emission to the predicted speed profile for predicting emissions on the road network portion being considered, the emissions model being a model relating the vehicle speed to the emissions.

It is thus possible to determine emissions at the scale of a district, a city, etc., even when no travelled route data is available for this district or this city.

These steps can be carried out by a computer.

Advantageously, the method can comprise an optional step of displaying the emissions for the road network portion being considered. In this optional step, the emissions can be displayed on a road map. This display can be a rating or a color code. Optionally, a rating or a color code can be associated with each connection of the road network. It can be displayed on board a vehicle: on the dashboard, on an autonomous mobile device such as a geolocation device (of GPS type), a mobile phone (of smartphone type). It is also possible to display the emissions on a website. Furthermore, the predicted emissions can be shared with the public authorities (road maintenance management for example) and public works companies. Thus, the public authorities and the public works companies can optimize the road infrastructure in order to improve emissions levels.

Furthermore, the present invention relates to a method of predicting the consumption of a vehicle on a portion of a road network. For this vehicle consumption prediction method, the following steps are carried out:
a) predicting at least one vehicle speed profile on the road network portion being considered by use of the method of predicting at least one speed profile according to any one of the variants or variant combinations described above; and
b) applying a vehicle consumption model to the predicted speed profile for predicting the consumption of the vehicle on the road network portion being considered, the vehicle consumption model being a model relating the vehicle speed to the vehicle consumption.

It is thus possible to determine the vehicle consumption at the scale of a district, a city, etc., even when no travelled route data is available for this district or this city.

These steps can be carried out by a computer.

Advantageously, the method can comprise an optional step of displaying the consumption for the road network portion being considered. In this optional step, the consumption can be displayed on a road map. This display can be a rating or a color code. Optionally, a rating or a color code can be associated with each connection of the road network. It can be displayed on board a vehicle: on the dashboard, on an autonomous mobile device such as a geolocation device (of GPS type), a mobile phone (of smartphone type). It is also possible to display the vehicle consumption on a website. Furthermore, the vehicle consumption can be shared with the public authorities (road maintenance management for example) and public works companies. Thus, the public authorities and the public works companies can optimize the road infrastructure, the location of service stations, of charging stations, etc.

Furthermore, the invention relates to a method of determining a route to be travelled by a user, for which the departure and the arrival are identified, by carrying out the following steps:
a) predicting at least one vehicle speed profile on the road network portion being considered by use of the method of predicting at least one speed profile according to any one of the variants or variant combinations described above; and
b) determining a route to be travelled for connecting the departure and the arrival, by accounting for the predicted speed profile.

Step b) can minimize conventional navigation method criteria such as travel time, distance travelled, energy consumption, etc. Moreover, step b) can minimize the associated risk by use of the associated probability distribution. These minimization criteria depend on the vehicle speed. Therefore, the accuracy obtained by the speed profile prediction method allows optimizing the determination of the route to be travelled.

For step b), a shortest-path algorithm can be used.

These steps can be carried out by a computer.

Advantageously, the method can comprise an optional step of displaying the route to be travelled, possibly with the speed profile for each route connection. In this optional step, the route can be displayed on a road map. It can be displayed on board a vehicle: on the dashboard, on an autonomous mobile device such as a geolocation device (of GPS type), a mobile phone (of smartphone type). It is also possible to display the route to be travelled by the vehicle on a website. Furthermore, the route to be travelled by the vehicle can be shared with a vehicle fleet manager.

### EXAMPLES

The features and advantages of the method according to the invention will be clear from reading the comparative examples hereafter.

In order to validate the representativity of the predicted speed profiles and generated by the method according to the invention (according to an embodiment wherein steps 1.1 to 1.4 and 2.1 to 2.3 are carried out), a qualitative as well as quantitative validation has been performed on a subset of connections of the learning base (macroscopic road network data and data relative to routes travelled in Lyon and Paris) and, by extrapolation, on a subset of connections outside the learning base (macroscopic road network data and data relative to routes travelled in Marseille). The quantitative representativity analysis of the generated speed profiles has been carried out in relation to at least one of the fuel consumption and the emissions associated with the speed profiles (this quantitative analysis could also have been performed in relation to consumption, noise or safety). The emissions associated with the real speed profiles of the travelled route data calculated with a microscopic emissions model (based on the speed trace acquired at 1 hz) have been used as a reference, one reference per class being thus obtained (according to the classes defined in step 1.3). The emissions associated with the speed profiles generated by classification have been compared with their reference.

The first example relates to a segment (connection) belonging to the learning road network (Paris/Lyon), which has not been directly used in the neural network learning for generating the vehicle speed model (step 1.4).

An uncongested or minimally congested connection with a traffic light at the end of the connection has been selected for speed profile prediction. After identifying the corresponding category (uncongested or minimally congested connection with a traffic light—step 1.2) and associating two classes with this category (green light class and red light class—step 1.3), the neural networks were used to estimate the parameters of the speed profiles (initial speed, final speed, stop point, maximum speed) according to the macroscopic data of the connection being considered.

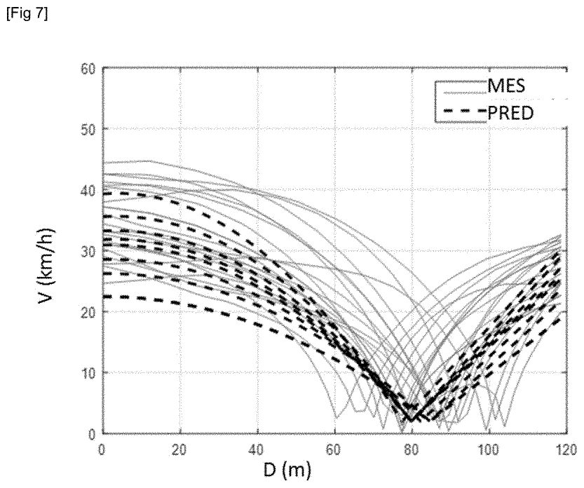

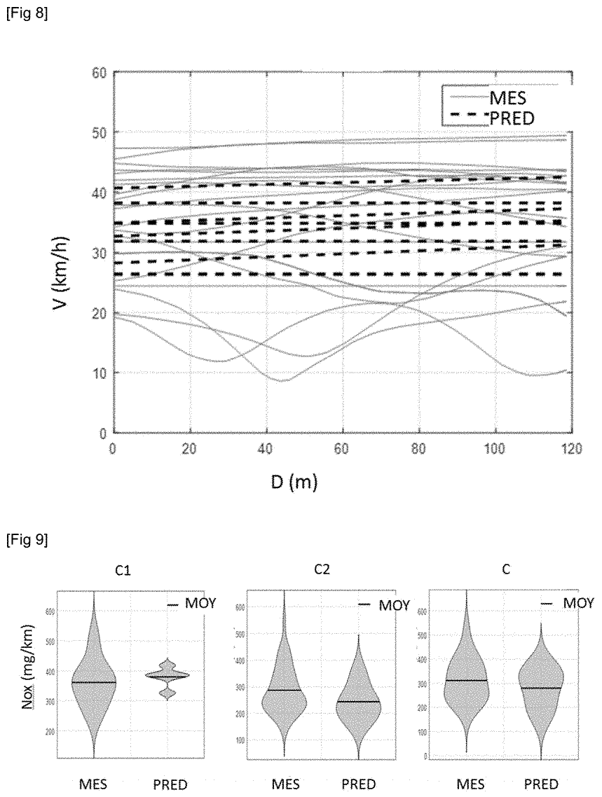

FIG. 7 illustrates profiles of speed V (km/h) as a function of distance D (m) in the case of a connection with a red traffic light. FIG. 8 illustrates profiles of speed V (km/h) as a function of distance D (m) in the case of a connection with a green traffic light. The speed profiles illustrated correspond to the measured speed profiles MES and to the speed profiles PRED predicted by use of the method according to the invention. Qualitatively, the predicted speed profiles PRED reproduce well the form of the real profiles MES (acceleration level, speed, stop point position) in these two situations.

In order to assess the representativity of the predicted profiles, a comparison was made in terms of NOx emissions (for a selected vehicle type) with the emissions associated with the real speed profiles. The comparison results for the segment being considered are shown in FIG. 9. FIG. 9 illustrates a comparison for three cases: case C1 corresponding to the red light, case C2 corresponding to the green light and case C corresponding to all the cases (C=C1+C2). FIG. 9 illustrates, for each case, the distribution of the NOx emissions in mg/km (grey surface) for the measured speeds MES and for speeds PRED predicted by use of the method according to the invention. On each curve, the horizontal line MOY indicates the average value of the NOx emissions. It is noted that, in the three cases, the average obtained with the predicted speed values PRED is close to the average obtained with measured speed values MES. Furthermore, a statistical analysis of the impact of the speed profile prediction accuracy on the emissions has also been performed. Of all the road segments with a traffic light at the end of the connection present in the learning network (328 connections), the mean absolute error on the emissions is 10 mg/km, with a 6% percentage error. Thus, the method according to the invention enables prediction of the speed profiles and of the emissions in an accurate and representative manner.

The second example relates to a road segment (connection) in Marseille that does not belong to the learning road network, which has therefore not been directly used in the neural network learning.

In analogy with the previous example, a connection with a traffic light at the end of the connection has been selected for prediction of the speed profiles. This time, the connection does not belong to the learning network data in order to check the capacity of the invention to extrapolate and to generalize information (data). After identifying the corresponding category (uncongested or minimally congested connection with a traffic light) and associating two classes with this category (green light class, red light class), the neural networks were used to estimate the parameters of the speed profiles (initial speed, final speed, stop point, maximum speed) according to the macroscopic connection data.

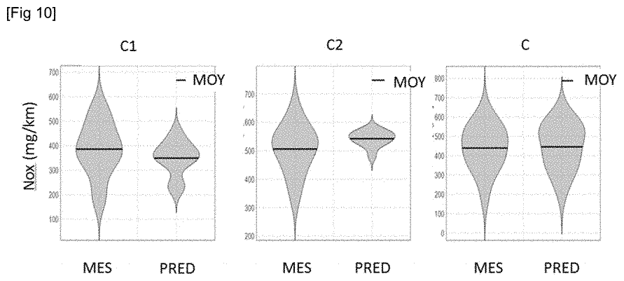

In order to assess the representativity of the predicted profiles, a comparison was made in terms of NOx emissions (for a selected vehicle type) with the emissions associated with the real speed profiles. The comparison results for the segment considered are shown in FIG. 10. FIG. 10 illustrates a comparison for three cases: case C1 corresponding to the red light, case C2 corresponding to the green light and case C corresponding to all the cases (C=C1+C2). FIG. 10 illustrates, for each case, the distribution of the NOx emissions in mg/km (grey surface) for the measured speeds MES and for speeds PRED predicted by use of the method according to the invention. On each curve, the horizontal line MOY indicates the average value of the NOx emissions. It is noted that, in the three cases, the average obtained with the predicted speed values PRED is close to the average obtained with measured speed values MES.

Furthermore, a statistical analysis of the impact of the speed profile prediction accuracy on the emissions has also been performed. Of all the road segments with a traffic light at the end of the connection present in the test road network (24 connections), the mean absolute error on the emissions is 37.8 mg/km, with a 7.5% percentage error. Thus, the method according to the invention enables prediction of the speed profiles and of the emissions in an accurate and representative manner.

1-15. (canceled)

16. A method of predicting at least one vehicle speed profile on a road network portion, comprising steps of:
a) constructing a vehicle speed model using a machine learning method by use of macroscopic data of the road network and by use of data relative to routes travelled on the road network, the vehicle speed model associating to at least one subdivision of the road network at least one vehicle speed profile according to the macroscopic data of the road network and the travelled route data; and
b) predicting at least one speed profile of the vehicle on the portion of the road network by applying the vehicle speed model to macroscopic data of each subdivision of the portion of the road network.

17. A method of predicting at least one speed profile as claimed in claim 16, wherein the vehicle speed model is constructed by steps of:
i) segmenting the road network by use of the macroscopic data of the road network;
ii) categorizing each segment of the road network according to the macroscopic data of the road network;
iii) for each road segment category, classifying the travelled route data, and
iv) for each road segment category and for each classification of the travelled route data, generating at least one vehicle speed profile by use of the travelled route data.

18. A method of predicting at least one speed profile as claimed in claim 17, wherein at least one vehicle speed profile is predicted for the portion of the road network by steps of:
i) segmenting the portion of the road network;
ii) categorizing the segments of the portion of the road network; and
iii) assigning to each segment of the portion of the road network the at least one vehicle speed profile generated by use of the vehicle speed model.

19. A method of predicting at least one speed profile as claimed in claim 18, wherein the at least one speed profile is assigned to each segment of the portion of the road network by accounting for data relative to routes travelled on each segment to clarify the at least one speed profile.

20. A method of predicting at least one speed profile as claimed in claim 17, wherein a distribution of the at least one speed profile is also assigned to each segment of the portion of the road network.

21. A method of predicting at least one speed profile as claimed in claim 17, wherein the road network is segmented by dividing the road network into connection triplets with each connection triplet having a connection formed between two nodes of the road network which are an origin and a destination.

22. A method of predicting at least one speed profile as claimed in claim 21, wherein the category of the road network segment is selected from:
a) a congested road,
b) an uncongested or minimally congested road with a traffic light,
c) an uncongested or minimally congested road without a traffic light and with an intersection with right of way,
d) an uncongested or minimally congested road without a traffic light and with an intersection without right of way,
e) an uncongested or minimally congested road without a traffic light and with a bend having a small curvature, and
f) an uncongested or minimally congested road without a traffic light and with a bend having a large curvature.

23. A method of predicting at least one speed profile as claimed in claim 17, wherein the travelled route data is classified by the k-means classification algorithm.

24. A method of predicting at least one speed profile as claimed in claim 17, wherein at least one vehicle speed profile is generated by use of a method based on at least one neural network to parametrize a speed function depending on distance and the speed function is a linear function, a parabolic function, or a combination of at least one of linear and parabolic functions of distance.

25. A method of predicting at least one speed profile as claimed in claim 16, wherein the macroscopic data of the road network is topology and traffic conditions with the macroscopic data of the road network being provided by a geographic information system.

26. A method of predicting at least one speed profile as claimed in claim 16, wherein the travelled route data comprises speed, position and altitude data measured during prior trips by use of a geolocation system.

27. A method of predicting at least one speed profile as claimed in claim 16, wherein the at least one vehicle speed profile of the road network portion is displayed on a road map displayed on a smartphone or a computer system.

28. A method of predicting at least one of chemical and noise emissions on a road network portion, comprising steps of:
a) predicting at least one vehicle speed profile on the portion of the road network by use of the method of predicting at least one speed profile as claimed in claim 16; and
b) applying a microscopic model of at least one of chemical and noise emissions to the at least one speed profile for predicting the emissions, and the model relating the vehicle speed to the emissions.

29. A method of predicting the consumption of a vehicle on a road network portion, comprising steps of:
a) predicting at least one vehicle speed profile on the portion of the road network by use of the method of predicting at least one speed profile as claimed in claim 16; and
b) applying a vehicle consumption model to the at least one speed profile for predicting the consumption of the vehicle with the model relating the vehicle speed to the consumption of the vehicle.

30. A method of determining a route to be travelled by a vehicle, for which the departure and arrival of the route are identified, by carrying out the following steps:
a) predicting at least one vehicle speed profile on the portion of the road network by means of the method of predicting at least one speed profile as claimed in claim 16; and
b) determining a route to be travelled for connecting the departure and the arrival, by accounting for the at least one vehicle speed profile by minimizing travel time.
